(19) United States
(12) Patent Application Publication
(10) Pub. No.: US 2023/0330750 A1
(43) Pub. Date: Oct. 19, 2023

(54) METHOD OF OPERATING AN IRRADIATION SYSTEM, IRRADIATION SYSTEM AND APPARATUS FOR PRODUCING A THREE-DIMENSIONAL WORK PIECE WITH POLARIZATION CONTROL

(71) Applicant: SLM SOLUTIONS GROUP AG, Luebeck (DE)

(72) Inventors: Christopher Stengel, Luebeck (DE); Maximilian Schniedenharn, Luebeck (DE); Toni Adam Krol, Luebeck (DE)

(21) Appl. No.: 18/029,483

(22) PCT Filed: Sep. 13, 2021
(86) PCT No.: PCT/EP2021/075042

§ 371 Date: Mar. 30, 2023

(30) Foreign Application Priority Data
Oct. 2, 2020 (DE) 10 2020 125 796.1

(51) Int. Cl. B22F 10/366; B22F 12/90; B22F 12/45; B22F 12/41

(52) U.S. Cl. CPC B22F 10/366; B22F 12/90; B22F 12/45; B22F 12/41; B22F 2203/03; B22F 2201/10

(57) ABSTRACT

In a method of operating an irradiation system (10) for irradiating layers of a raw material powder with laser radiation in order to produce a three-dimensional work piece (110) at least a section of a raw material powder layer (11) applied onto a carrier (102) is selectively irradiated with linearly polarized laser radiation. An orientation of a plane of polarization of the linearly polarized laser radiation is controlled in dependence on an orientation of a plane of incidence of the linearly polarized laser radiation on the raw material.

The invention is directed to a method of operating an irradiation system for irradiating layers of a raw material powder with laser radiation in order to produce a three-dimensional work piece. Further, the invention is directed to an irradiation system of this kind. Finally, the invention is directed to an apparatus for producing a three-dimensional work piece.

Powder bed fusion is an additive layering process by which pulverulent, in particular metallic and/or ceramic raw materials can be processed to three-dimensional work pieces of complex shapes. To that end, a raw material powder layer is applied onto a carrier and subjected to laser radiation in a site selective manner in dependence on the desired geometry of the work piece that is to be produced. The laser radiation penetrating into the powder layer causes heating and consequently melting or sintering of the raw material powder particles. Further raw material powder layers are then applied successively to the layer on the carrier that has already been subjected to laser treatment, until the work piece has the desired shape and size. Powder bed fusion may be employed for the production or repairing of prototypes, tools, replacement parts, high value components or medical prostheses, such as, for example, dental or orthopaedic prostheses, on the basis of CAD data.

An exemplary apparatus for producing three-dimensional work pieces by powder bed fusion as described, e.g., in WO 2019/141381 A1, comprises a carrier configured to receive multiple layers of raw material and an irradiation unit configured to selectively irradiate laser radiation onto the raw material on the carrier in order to produce a work piece. The irradiation unit is provided with a spatial light modulator configured to split a laser beam into at least two sub-beams. In order to provide the spatial light modulator with a linearly polarized laser beam, a polarization means which performs a linear polarization of the laser beam is provided upstream of the spatial light modulator.

Upon building up a three-dimensional work piece on the carrier of a powder bed fusion apparatus, the absorption of laser radiation impinging onto the raw material powder causes the raw material powder to melt and/or sinter so that a melt pool of molten raw material is generated. Further, the evaporation of raw material leads to the formation of a vapor capillary via which the laser beam penetrates into deeper regions of the raw material.

It is an object of the present invention to provide a method of operating an irradiation system for irradiating layers of a raw material powder with laser radiation in order to produce a three-dimensional work piece and an irradiation system of this kind which allow an efficient production of a high-quality work piece. Further, the invention is directed to an apparatus for producing a three-dimensional work piece which is equipped with an irradiation system which allows an efficient production of a high-quality work piece.

In a method of operating an irradiation system for irradiating layers of a raw material powder with laser radiation in order to produce a three-dimensional work piece, at least a section of a raw material powder layer applied onto a carrier is selectively irradiated with linearly polarized laser radiation. The raw material powder layer may be applied onto a surface of the carrier by means of a powder application device which is moved across the carrier so as to distribute the raw material powder. The carrier may be a rigidly fixed carrier. Preferably, however, the carrier is designed to be displaceable in vertical direction, so that, with increasing construction height of the work piece, as it is built up in layers from the raw material powder, the carrier can be moved downwards in the vertical direction. Further, the carrier may be provided with a cooling device and/or a heating device which are configured to cool and/or heat the carrier.

The carrier and the powder application device may be accommodated within a process chamber which is sealable against the ambient atmosphere. An inert gas atmosphere may be established within the process chamber by introducing a gas stream into the process chamber via a gas inlet. After being directed through the process chamber and across the raw material powder layer applied onto the carrier, the gas stream may be discharged from the process chamber via a gas outlet. The raw material powder applied onto the carrier within the process chamber is preferably a metallic powder, in particular a metal alloy powder, but may also be a ceramic powder or a powder containing different materials. The powder may have any suitable particle size or particle size distribution. It is, however, preferable to process powders of particle sizes <100 μm.

The irradiation system may comprise a laser beam source which emits at least one beam of linearly polarized laser light. In particular, the laser beam source of the irradiation system may emit linearly polarized laser light at a wavelength of 532 nm, i.e. “green” laser light. It is, however, also conceivable that the laser beam source of the irradiation system emits at least one beam of random polarized (i.e. non-polarized) laser light which is converted into a linearly polarized laser light beam by a suitable polarization device such as, for example, a polarizer or a polarizing beam splitter cube. If one or more beam splitter cubes are used to split the laser light beam into two or more partial beams with different polarization, only one partial beam may be used as irradiation beam while obstructing the other partial beams. Alternatively one or more partial beams may be guided to different irradiation systems in one or more additive manufacturing apparatuses. Additionally or alternatively one or more partial beams may be modified, especially its polarization may be changed. Additionally or alternatively several beams may be modified to obtain the same polarization and may be combined before guided collectively to an irradiation system.

The irradiation system may irradiate the raw material powder layer with a single laser beam. It is, however, also conceivable that the irradiation system irradiates two or more laser beams onto the raw material powder layer. In case the irradiation system irradiates the raw material powder layer with two or more laser beams, at least one laser beam may be a beam of linearly polarized laser light and at least one further laser beam may be a beam of random polarized laser light, a beam of radially polarized laser light and/or a beam of azimuthally polarized laser light. The plural laser light beams irradiated onto the raw material powder layer by the irradiation system may be emitted by suitable sub-units of the laser beam source.

The irradiation system may also comprise at least one optical unit for splitting, guiding and/or processing the at least one laser beam emitted by the laser beam source. The optical unit may comprise optical elements such as an object lens and a scanner unit, the scanner unit preferably comprising a diffractive optical element and a deflection mirror.

In the method of operating an irradiation system, an orientation of a plane of polarization of the linearly polarized laser radiation is controlled in dependence on an orientation of a plane of incidence of the linearly polarized laser radiation on the raw material. The term “plane of polarization” as used herein refers to a plane which is defined by a propagation vector of the incident laser beam and an electric field vector of the electromagnetic laser light wave and hence coincides with a plane of vibration of the electric field of the electromagnetic laser light wave. The term “plane of incidence” as used herein refers to a plane which is defined by the propagation vector of the incident laser beam and a surface normal which extends perpendicular to a raw material surface onto which the incident laser beam impinges.

The orientation of the plane of polarization of the linearly polarized laser radiation relative to the plane of incidence of the linearly polarized laser radiation on the raw material has a strong influence on the absorption of the laser energy by the raw material. Thus, by controlling the orientation of the plane of polarization in dependence on the plane of incidence of the linearly polarized laser radiation on the raw material, the absorption of the energy of the linearly polarized laser light by the raw material can be controlled.

By taking into consideration and actively controlling the absorption of the laser energy by the raw material an improved process stability upon producing three-dimensional work pieces can be achieved. Further, by increasing the absorption of the laser energy in a controlled manner, the process productivity can be increased. Consequently, high-quality work pieces can be produced in a particularly efficient way. In addition, materials such as for example Cu and Cu alloys, which at present are difficult to process by laser or sintering/melting may become processible by irradiating a respective raw material powder with linearly polarized laser radiation while controlling the orientation of a plane of polarization of the linearly polarized laser radiation in dependence on an orientation of a plane of incidence of the linearly polarized laser radiation on the raw material.

In a preferred embodiment of the method of operating an irradiation system, the orientation of the plane of polarization of the linearly polarized laser radiation is controlled in dependence on the orientation of the plane of incidence of the linearly polarized laser radiation on the raw material such that the plane of polarization is oriented substantially parallel to the plane of incidence. In other words, the orientation of the plane of polarization of the linearly polarized laser radiation is controlled relative to the orientation of the plane of incidence of the linearly polarized laser radiation on the raw material such that a p-pol state is reached.

In the p-pol state, the absorption of the energy of the linearly polarized laser radiation by the raw material generally is higher than in a s-pol state, wherein the plane of polarization extends perpendicular to the plane of incidence. In addition, the absorption of linearly polarized laser radiation in the p-pol state is generally also higher than the absorption of random polarized laser radiation. Consequently, by controlling the orientation of the plane of polarization relative to the orientation of the plane of incidence such that a p-pol state is reached, the absorption of the laser energy can be increased in a controlled manner.

Preferably, the orientation of the plane of polarization of the linearly polarized laser radiation is controlled in dependence on the orientation of the plane of incidence of the linearly polarized laser radiation on an inner wall surface of a capillary extending from a surface of the raw material powder layer into a volume of the raw material powder layer and being formed due to an interaction of the linearly polarized laser radiation with the raw material. The capillary may be a vapor capillary which is formed due to the evaporation of raw material heated by the absorption of the energy of the laser beam impinging on the raw material layer. The size and shape of the capillary may depend on various parameters, such as a power, a focus diameter and a focus shape of the incident laser beam, a scan speed and a scan direction of the laser beam and/or at least one parameter of a gas flow which is directed across the raw material powder layer in order to establish a controlled atmosphere within the process chamber and in order to remove particulate impurities, such as splash particles, smoke particles or soot particles, that are generated upon irradiating the raw material powder layer.

The laser beam irradiated onto the raw material powder layer penetrates into the capillary and impinges on an inner wall surface of the capillary which has a different orientation than an upper surface of the raw material powder layer. For example, the surface of the inner wall of the capillary onto which the laser beam impinges may extend at an angle of approximately 45 to 90°, preferably at an angle of approximately 60 to 80° relative to the upper surface of the raw material powder layer which typically is oriented substantially parallel to a surface of the carrier onto which the raw material powder layer is applied. By considering the orientation of the plane of incidence of the linearly polarized laser radiation on an inner wall surface of the capillary formed due to the interaction of the laser beam with the raw material upon controlling the orientation of the plane of polarization of the linearly polarized laser radiation, a particularly reliable and accurate control of the absorption of the laser energy by the raw material is made possible.

A change of the scan direction of the laser beam across the raw material powder layer usually leads to a change of the orientation of the plane of incidence of the linearly polarized laser radiation on the raw material. Therefore, upon controlling the orientation of the plane of polarization of the linearly polarized laser radiation in dependence on the orientation of the plane of incidence of the linearly polarized laser radiation on the raw material, the orientation of the plane of polarization of the linearly polarized laser radiation preferably is updated in dependence on the scan direction of the linearly polarized laser radiation across the raw material powder layer.

For updating the orientation of the plane of polarization of the linearly polarized laser radiation, a polarization device, for example a wave plate, in particular a half-wave plate, may be rotated. Alternatively, a collimator which, in an optical path of the laser light emitted from the radiation beam source, is arranged downstream of the polarization device may be rotated. Further, at least one deflection mirror, in particular a pair of deflection mirrors, for deflecting the beam of linearly polarized laser radiation as needed may be employed. Additionally, for deflecting the beam of linearly polarized laser light there may be two pairs of deflection mirrors employed, one to effect the rotation of the plane of polarization and one to effect the deflection of the beam. In a preferred embodiment, mirrors with metallic coatings (e.g. aluminium, silver, gold, etc.) are used.

The orientation of the plane of polarization of the linearly polarized laser radiation may be updated based on an analysis of a scan pattern according to which the beam of linearly polarized laser radiation is directed across the raw material powder layer. By analyzing the scan pattern, changes of the scan direction of the laser beam across the raw material powder layer may be determined. Consequently, the orientation of the plane of polarization of the linearly polarized laser radiation may be updated as needed and synchronized with the operation of the scanner unit which scans the laser beam across the raw material powder layer. The analysis of the scan pattern may be performed prior to starting the production of the three-dimensional work piece and/or in situ during the production of the three-dimensional work piece.

The absorption of the energy of the linearly polarized laser radiation by the raw material strongly depends on an angle of incidence of the laser beam on the raw material. In the p-pol state and at least for angles of incidence between approximately 10 and 80°, the absorption increases with an increasing angle of incidence. The term “angle of incidence” as used herein refers to an angle between the propagation vector of the incident laser beam and the surface normal which extends perpendicular to the raw material surface onto which the incident laser beam impinges.

For selectively irradiating the raw material powder layer, i.e. for scanning the laser beam across the raw material powder layer, the laser beam is deflected relative to a surface normal extending perpendicular to the upper surface of the raw material powder layer. Consequently, the angle of incidence depends on an angle of deflection of the incident laser beam relative to the surface normal extending perpendicular to the upper surface of the raw material powder layer and hence an operational state of the scanner unit. In addition, the angle of incidence depends on an orientation of the raw material surface onto which the incident laser beam impinges.

Besides the angle of incidence of the linearly polarized laser beam, a number of further process parameters may influence the absorption of the laser energy by the raw material. These parameters may include a power, a focus diameter and a focus shape of the beam of linearly polarized laser radiation. Further, a scan speed, a scan mode (leading or trailing), a scan direction and a scan pattern according to which the laser beam is directed across the raw material powder layer may have an effect on the absorption of the laser energy by the raw material. Also the gas flow which is directed through the process chamber and across the surface of the raw material powder layer, in particular a volume flow and a flow speed of the gas flow as well as the type of gas may influence the absorption.

Therefore, in a preferred embodiment of the method of operating an irradiation system, at least one of a power, a focus diameter and a focus shape of a beam of linearly polarized laser radiation and/or at least one of a scan speed, a scan mode, a scan direction and a scan pattern according to which the beam of linearly polarized laser radiation is directed across the raw material powder layer and/or at least one parameter of a gas flow directed across the raw material powder layer is controlled in dependence on the angle of incidence of the beam of linearly polarized laser radiation on the raw material.

By correlating the angle of incidence of the linearly polarized laser beam with (a) further process parameter(s) which influence(s) the absorption of the laser energy by the raw material may, on the one hand, a particularly reliable control of the absorption may be achieved and overheating of the raw material may be avoided. On the other hand, the procedural efficiency may be increased. For example, a decrease of the absorption which results from a reduction of the laser power and/or an increase of the scan speed may be compensated by the increased absorption at suitable angles of incidence. Further, for specific raw materials, the energy applied to the raw materials may be increased in a controlled manner by suitably controlling the angle of incidence, for example in order to allow processing of these materials.

A beam of linearly polarized laser radiation may be scanned across the raw material powder layer according to a scan strategy, wherein a plurality of scan vectors pointing in a first vector direction are successively scanned, before at least one scan vector pointing in a second vector direction which differs from the first vector direction is scanned. A scan vector pointing in a first vector direction v1 can be scanned “forwards” in a direction +v1 and “backwards” in a direction without changing the orientation of the plane of polarization of the linearly polarized laser radiation. Similarily, a scan vector pointing in a second vector direction v2 can be scanned “forwards” in a direction +v2 and “backwards” in a direction −v2 without changing the orientation of the plane of polarization of the linearly polarized laser radiation. Thus, a change of the orientation of the plane of polarization of the linearly polarized laser radiation is only required in case the vector direction, i.e. a direction of extension of the vector is changed. With such a scan strategy the “number of updates” of the orientation of the plane of polarization of the linearly polarized laser radiation can be reduced. Consequently, the updating process can be simplified.

In an embodiment of the method of operating an irradiation system, a first section of the raw material powder layer may be selectively irradiated with linearly polarized laser radiation and a second section of the raw material powder layer may be selectively irradiated with randomized laser radiation, radially polarized laser radiation and/or azimuthally polarized laser radiation. The second section may be a section of the raw material powder layer which is intended to be irradiated according to a scan strategy which requires a frequent and/or fast updating of the orientation of the plane of polarization of the linearly polarized laser radiation. For example, the second section may be a section of the raw material powder layer which is intended to be irradiated according to a scan pattern which comprises a high density of short scan vectors and/or scan vectors pointing in a plurality of directions and/or which is intended to be irradiated at a high scan speed.

In particular, the first section of the raw material powder layer may be a hatch section of a work piece layer generated by selectively irradiating the raw material powder layer. The second section of the raw material powder layer may be a contour section of a work piece layer generated by selectively irradiating the raw material powder layer. Consequently, the advantages of irradiating the raw material powder layer with linearly polarized laser radiation as described above can be realized in the hatch section which typically forms the majority of the area of the work piece layer. At the same time, difficulties which may arise upon updating the orientation of the plane of polarization in the contour section may be avoided.

In a further embodiment of the method of operating an irradiation system, a plurality of beams of linearly polarized laser radiation may be scanned across an overlap section of the raw material powder layer according to a scan strategy, wherein all scan vectors are scanned according to the same scan mode. The term “overlap section” as used herein defines a section of the raw material powder layer which can be irradiated with more than one laser beam. For example, in the overlap section of the raw material powder layer, all scan vectors are scanned according to a trailing scan mode or all scan vectors are scanned according to a leading scan mode. Thus, in the overlap section, the absorption of the laser radiation by the raw material is not influenced by the scan mode and hence can be controlled more reliably.

An irradiation system for irradiating layers of a raw material powder with laser radiation in order to produce a three-dimensional work piece is configured to selectively irradiate at least a section of a raw material powder layer applied onto a carrier with linearly polarized laser radiation. The irradiation system comprises a control device, which is configured to control an orientation of a plane of polarization of the linearly polarized laser radiation in dependence on an orientation of a plane of incidence of the linearly polarized laser radiation on the raw material.

The control device of the irradiation system may be configured to control the orientation of the plane of polarization of the linearly polarized laser radiation in dependence on the orientation of the plane of incidence of the linearly polarized laser radiation on the raw material such that the plane of polarization is oriented substantially parallel to the plane of incidence. Thus, a p-pol state can be achieved.

The control device may further be configured to control the orientation of the plane of polarization of the linearly polarized laser radiation in dependence on the orientation of the plane of incidence of the linearly polarized laser radiation on an inner wall surface of a capillary extending from a surface of the raw material powder layer into a volume of the raw material powder layer and being formed due to an interaction of the linearly polarized laser radiation with the raw material.

Moreover, the control device, upon controlling the orientation of the plane of polarization of the linearly polarized laser radiation in dependence on the orientation of the plane of incidence of the linearly polarized laser radiation on the raw material, may be configured to update the orientation of the plane of polarization of the linearly polarized laser radiation in dependence on a scan direction of the linearly polarized laser radiation across the raw material powder layer.

Specifically, the control device may be configured to update the orientation of the plane of polarization of the linearly polarized laser radiation based on an analysis of a scan pattern according to which the beam of linearly polarized laser radiation is directed across the raw material powder layer. The analysis of the scan pattern may be performed prior to starting the production of the three-dimensional work piece and/or in situ during the production of the three-dimensional work piece.

The control device may further be configured to control at least one of a power, a focus diameter and a focus shape of a beam of linearly polarized laser radiation and/or at least one of a scan speed, a scan direction, a scan mode and a scan pattern according to which the beam of linearly polarized laser radiation is directed across the raw material powder layer and/or at least one parameter of a gas flow directed across the raw material powder layer in dependence on an angle of incidence of the beam of linearly polarized laser radiation on the raw material.

Alternatively or additionally, the control device may be configured to control a scanner unit such that a beam of linearly polarized laser radiation is scanned across the raw material powder layer according to a scan strategy, wherein a plurality of scan vectors pointing in a first vector direction are successively scanned, before at least one scan vector pointing in a second vector direction which differs from the first vector direction is scanned.

Further, the control device may be configured to control the irradiation system such that a first section of the raw material powder layer is selectively irradiated with linearly polarized laser radiation and a second section of the raw material powder layer is selectively irradiated with randomized laser radiation, radially polarized laser radiation and/or azimuthally polarized laser radiation.

The first section of the raw material powder layer may be a hatch section of a work piece layer generated by selectively irradiating the raw material powder layer. The second section of the raw material powder layer may be a contour section of a work piece layer generated by selectively irradiating the raw material powder layer.

The control device may also be configured to control a scanner unit such that a plurality of beams of linearly polarized laser radiation are scanned across an overlap section of the raw material powder layer according to a scan strategy, wherein all scan vectors are scanned according to the same scan mode.

An apparatus for producing a three-dimensional work piece is equipped with an above-described irradiation system.

Preferred embodiments of the invention will be described in greater detail with reference to the appended schematic drawings, wherein

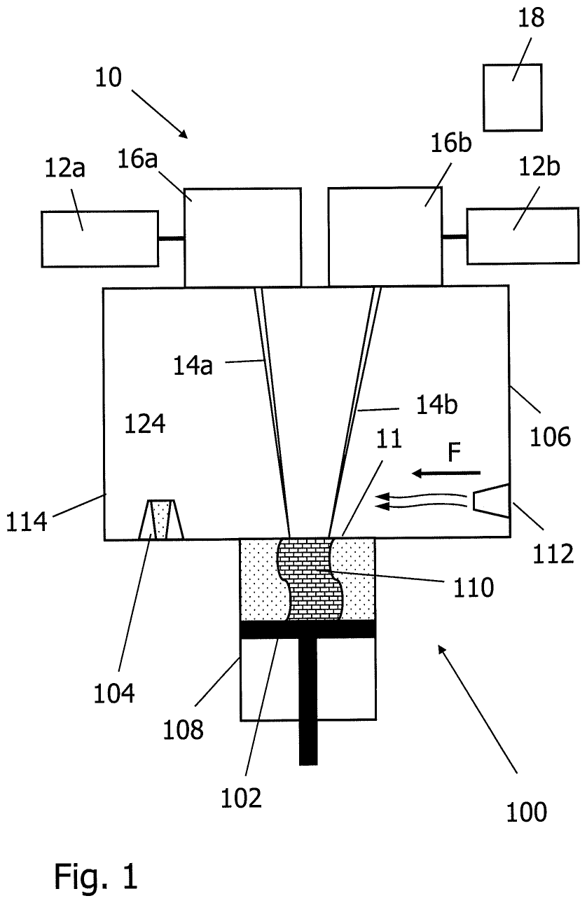

FIG. 1 shows an apparatus for producing a three-dimensional work piece by irradiating layers of a raw material powder with laser radiation;

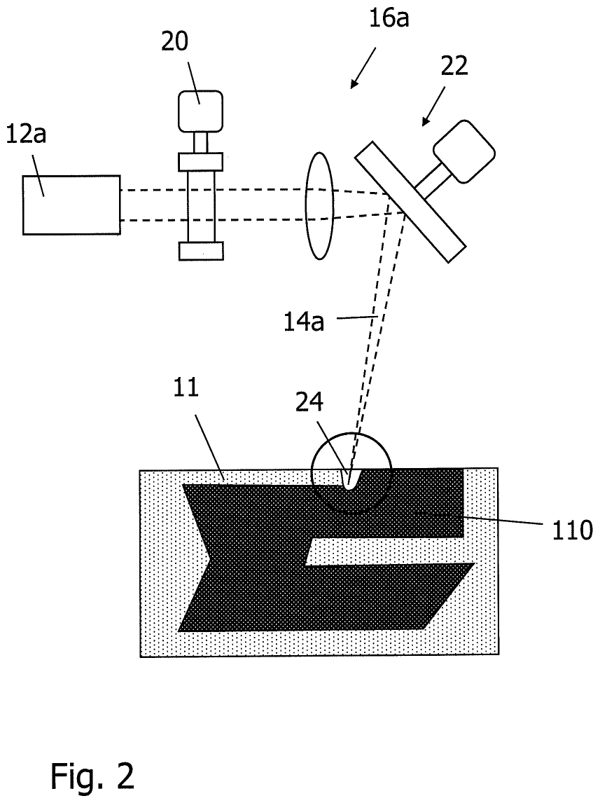

FIG. 2 an irradiation system employed in the apparatus of FIG. 1;

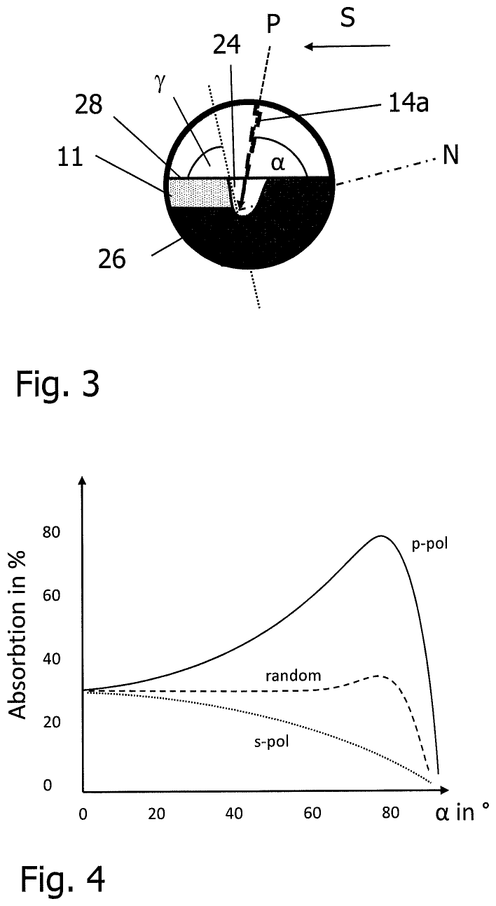

FIG. 3 illustrates the interaction of a beam of linearly polarized laser radiation with the raw material; and

FIG. 4 shows a diagram indicating the dependency of the absorption of laser radiation by the raw material on the polarization state of the laser radiation and the angle of incidence of the laser beam on the raw material.

FIG. 1 shows an apparatus 100 for producing a three-dimensional work piece by an additive layering process. The apparatus 100 comprises a carrier 102 and a powder application device 104 for applying a raw material powder onto the carrier 102. The carrier 102 and the powder application device 104 are accommodated within a 30 process chamber 106 which is sealable against the ambient atmosphere. The carrier 102 is displaceable in a vertical direction into a built cylinder 108 so that the carrier 102 can be moved downwards with increasing construction height of a work piece 110, as it is built up in layers from the raw material powder on the carrier 12. The carrier 102 may comprise a heater and/or a cooler.

The apparatus 100 further comprises an irradiation system 10 for selectively irradiating laser radiation onto the raw material powder layer 11 applied onto the carrier 102. In the embodiment of an apparatus 100 shown in FIG. 1, the irradiation system 10 comprises two laser beam sources 12a, 12b, each of which is configured to emit a laser beam 14a, 14b. An optical unit 16a, 16b for guiding and processing the laser beams 14a, 14b emitted by the laser beam sources 12a, 12b is associated with each of the laser beam sources 12a, 12b. It is, however, also conceivable that the irradiation system 10 is equipped with only one laser beam source and only one optical unit and consequently emits only a single laser beam. A control device 18 is provided for controlling the operation of the irradiation system 10 and further components of the apparatus 100 such as, for example, the powder application device 104.

A controlled gas atmosphere, preferably an inert gas atmosphere is established within the process chamber 106 by supplying a shielding gas to the process chamber 106 via a process gas inlet 112. After being directed through the process chamber 106 and across the raw material powder layer 11 applied onto the carrier 102, the gas is discharged from the process chamber 106 via a process gas outlet 114. The flow direction of the shielding gas from the process gas inlet 112 through the process chamber 106 to the gas process gas outlet 114 is indicated with the arrow F. The process gas may be recirculated from the process gas outlet 114 to the process gas inlet 112 and thereupon may be cooled or heated.

During operation of the apparatus 100 for producing a three-dimensional work piece, a layer 11 of raw material powder is applied onto the carrier 102 by means of the powder application device 104. In order to apply the raw material powder layer 11, the powder application device 104 is moved across the carrier 102 under the control of the control unit 18. Then, again under the control of the control unit 18, the layer 11 of raw material powder is selectively irradiated with laser radiation in accordance with a geometry of a corresponding layer of the work piece 110 to be produced by means of the irradiation device 10. The steps of applying a layer 11 of raw material powder onto the carrier 102 and selectively irradiating the layer 11 of raw material powder with laser radiation in accordance with a geometry of a corresponding layer of the work piece 110 to be produced are repeated until the work piece 110 has reached the desired shape and size.

At least one of the laser beams 14a, 14b irradiated across the raw material powder layer 11 by the irradiation system 10 is a beam of linearly polarized laser radiation. A more detailed illustration of the laser beam source 12a and the optical unit 16a is shown in FIG. 2. The laser beam source 12a emits linearly polarized laser light, for example laser light at a wavelength 450 nm, i.e. “blue” laser light, or laser light at a wavelength of 532 nm, i.e. “green” laser light, or laser light at a wavelength in the rage of 1000 nm to 1090 nm or in the range of 1530 nm to 1610 nm, i.e. “infrared” laser light. The polarization device 20 is used for the rotation of the plane of polarization and may, for example, be designed in the form of a rotatably mounted wave plate, in particular a half-wave plate. The linearly polarized laser beam 14a is scanned across the raw material powder layer 11 by means of a scanner unit 22.

The laser energy introduced into the raw material powder by the laser beam 14a impinging onto the raw material powder layer 11 causes the raw material powder to melt and/or sinter. Specifically, a melt pool of molten raw material is generated in a region where the laser beam 14a impinges on the raw material powder. Further, a vapor capillary 24, which is illustrated in greater detail in FIG. 3, is formed due to the evaporation of raw material heated by the absorption of the energy of the laser beam 14a impinging on the raw material.

The laser beam 14a penetrates into the capillary 24 and impinges on an inner wall surface 26 of the capillary 24 which has a different orientation than an upper surface 28 of the raw material powder layer 11. In the exemplary embodiment illustrated in FIG. 3, the surface 26 of the inner wall of the capillary onto which the laser beam impinges extends at an angle γ of approximately 75 to 80° relative to the upper surface 28 of the raw material powder layer 11 which is oriented substantially parallel to a surface of the carrier 102.

In the exemplary embodiment illustrated in FIG. 3, the laser beam 14a is scanned across the raw material powder layer 11 in a scan direction indicated by the arrow S in a leading scan mode. A plane of incidence of the laser beam 14a on the raw material, i.e. on the surface 26 of the inner wall of the capillary 24, is defined by a propagation vector P of the incident laser beam 14a and a surface normal N which extends perpendicular to a raw material surface 26 onto which the incident laser beam 14a impinges. An angle of incidence α is defined between the propagation vector P of the incident laser beam 14a and the surface normal N.

During operation of the irradiation system 10, the control device 18 controls an orientation of a plane of polarization of the linearly polarized laser beam 14a in dependence on an orientation of the plane of incidence of the linearly polarized laser beam 14a on the raw material. Specifically, the control device 18 controls the orientation of the plane of polarization of the linearly polarized laser beam 14a in dependence on the orientation of the plane of incidence of the linearly polarized laser beam 14a on the inner wall surface 26 of the capillary 24.

As becomes apparent from FIG. 4, the orientation of the plane of polarization of the linearly polarized laser radiation relative to the plane of incidence of the linearly polarized laser radiation on the raw material has a strong influence on the absorption of the laser energy by the raw material. In a p-pol state, which is defined by the orientation of the plane of polarization of the linearly polarized laser beam 14a being parallel to the orientation of the plane of incidence of the linearly polarized laser radiation on the raw material, the absorption of the laser energy by the raw material is higher than the absorption of the laser energy by the raw material in a s-pol state, which is defined by the orientation of the plane of polarization of the linearly polarized laser beam 14a being perpendicular to the orientation of the plane of incidence of the linearly polarized laser radiation on the raw material. In the p-pol state, the absorption of laser energy by the raw material is also higher than the absorption of the energy of a random polarized laser beam. Therefore, the control device 18 controls the orientation of the plane of polarization of the linearly polarized laser beam 14a in dependence on the orientation of the plane of incidence of the linearly polarized laser beam 14a on the raw material such that the plane of polarization is oriented substantially parallel to the plane of incidence, i.e. such that a p-pol state is reached.

A change of the scan direction S of the laser beam 14a across the raw material powder layer 11 leads to a change of the orientation of the plane of incidence of the linearly polarized laser beam 14a on the raw material. Therefore, the control device 18, upon controlling the orientation of the plane of polarization of the linearly polarized laser beam 14a in dependence on the orientation of the plane of incidence of the linearly polarized laser beam 14a on the raw material, updates the orientation of the plane of polarization of the linearly polarized laser beam 14a in dependence on the scan direction S of the linearly polarized laser beam 14a across the raw material powder layer 11.

In the exemplary arrangement of FIG. 2, the updating of the orientation of the plane of polarization of the linearly polarized laser beam 14a is achieved by appropriately rotating the polarization device 20. The control device 18 performs the updating of the orientation of the plane of polarization of the linearly polarized laser beam 14a based on an analysis of a scan pattern according to which the linearly polarized laser beam 14a is directed across the raw material powder layer 11. The analysis of the scan pattern may be performed prior to starting the production of the three-dimensional work piece 110 and/or in situ during the production of the three-dimensional work piece 110.

In order to simplify the updating of the orientation of the plane of polarization of the linearly polarized laser beam 14a, the linearly polarized laser 14a is scanned across the raw material powder layer 11 according to a scan strategy, wherein a plurality of scan vectors pointing in a first direction are successively scanned, before at least one scan vector pointing in a second direction which differs from the first direction is scanned. Such a scan strategy reduces the number of changes of the scan direction S and hence the number of rotations of the polarization device 20 which have to be performed to update the orientation of the plane of polarization of the linearly polarized laser beam 14a.

FIG. 4 further illustrates that the absorption of the energy of the linearly polarized laser radiation by the raw material strongly depends on the angle of incidence α of the laser beam 14a on the raw material. The angle of incidence α in turn depends on an angle of deflection of the incident laser beam 14a relative to a surface normal extending perpendicular to the upper surface 28 of the raw material powder layer 11 and hence an operational state of the scanner unit 22. In addition, the angle of incidence α depends on the orientation of the raw material surface 26 onto which the incident laser beam 14a impinges. In the p-pol state and at least for angles of incidence α between approximately 10 and 80°, the absorption increases with an increasing angle of incidence α. The relationship between absorption, angle of incidence and polarization may also be material-dependent and temperature-dependent.

In order to allow a particularly reliable control of the absorption of laser energy by the raw material, the control device 18, upon controlling the operation of the irradiation system 10, besides the angle of incidence α of the linearly polarized laser beam 14a, also considers a number of further process parameters that may influence the absorption of the laser energy by the raw material. Specifically, the control device 18 controls at least one of a power, a focus diameter and a focus shape of the linearly polarized laser beam 14a and/or at least one of the scan speed, the scan mode, the scan direction S and the scan pattern according to which the linearly polarized laser beam 14a is directed across the raw material powder layer 11 and/or at least one parameter of the gas flow directed across the raw material powder layer 11 in dependence on the angle of incidence α of the linearly polarized laser beam 14a on the raw material.

The laser beam source 12b and the optical unit 16b may be of the same design as the laser beam source 12a and the optical unit 16a, such that also the laser beam 14b is a linearly polarized laser beam 14b. In such a case, the control device 18 controls the operation of the irradiation system 10 in such a manner that the linearly polarized laser beams 14a, 14b are scanned across an overlap section of the raw material powder layer 11 according to a scan strategy, wherein all scan vectors are scanned according to the same scan mode. In particular, in the overlap section of the raw material powder layer 11, all scan vectors are scanned either according to a trailing scan mode or according to a leading scan mode in order to eliminate influences of the scan mode on the absorption of laser energy by the raw material.

It is, however, also conceivable that the laser beam source 12b and the optical unit 16b are configured to emit a randomized laser beam 14b, radially polarized laser beam 14b and/or an azimuthally polarized laser beam 14b. In such a case, a first section of the raw material powder layer 11 may be selectively irradiated with linearly polarized laser radiation and a second section of the raw material powder layer 11 may be selectively irradiated with randomized laser radiation, radially polarized laser radiation and/or azimuthally polarized laser radiation. Specifically, the first section of the raw material powder layer 11 may be a hatch section of a work piece layer generated by selectively irradiating the raw material powder layer 11 and the second section of the raw material powder layer 11 may be a contour section of a work piece layer generated by selectively irradiating the raw material powder layer 11.

1-17. (canceled)

18. Method of operating an irradiation system for irradiating layers of a raw material powder with laser radiation in order to produce a three-dimensional work piece, wherein at least a section of a raw material powder layer applied onto a carrier is selectively irradiated with linearly polarized laser radiation, and wherein an orientation of a plane of polarization of the linearly polarized laser radiation is controlled in dependence on an orientation of a plane of incidence of the linearly polarized laser radiation on the raw material.

19. The method according to claim 18,
wherein the orientation of the plane of polarization of the linearly polarized laser radiation is controlled in dependence on the orientation of the plane of incidence of the linearly polarized laser radiation on the raw material such that the plane of polarization is oriented substantially parallel to the plane of incidence.

20. The method of claim 18,
wherein the orientation of the plane of polarization of the linearly polarized laser radiation is controlled in dependence on the orientation of the plane of incidence of the linearly polarized laser radiation on an inner wall surface of a capillary extending from a surface of the raw material powder layer into a volume of the raw material powder layer and being formed due to an interaction of the linearly polarized laser radiation with the raw material.

21. The method of claim 18,
wherein, upon controlling the orientation of the plane of polarization of the linearly polarized laser radiation in dependence on the orientation of the plane of incidence of the linearly polarized laser radiation on the raw material, the orientation of the plane of polarization of the linearly polarized laser radiation is updated in dependence on a scan direction of the linearly polarized laser radiation across the raw material powder layer.

22. The method of claim 21,
wherein the orientation of the plane of polarization of the linearly polarized laser radiation is updated based on an analysis of a scan pattern according to which the beam of linearly polarized laser radiation is directed across the raw material powder layer, wherein the analysis of the scan pattern is performed prior to starting the production of the three-dimensional work piece and/or in situ during the production of the three-dimensional work piece.

23. The method of claim 18,
wherein at least one of a power, a focus diameter and a focus shape of a beam of linearly polarized laser radiation and/or at least one of a scan speed, a scan direction, a scan mode and a scan pattern according to which the beam of linearly polarized laser radiation is directed across the raw material powder layer and/or at least one parameter of a gas flow directed across the raw material powder layer is controlled in dependence on an angle of incidence of the beam of linearly polarized laser radiation on the raw material.

24. The method of claim 18,
wherein a beam of linearly polarized laser radiation is scanned across the raw material powder layer according to a scan strategy, wherein a plurality of scan vectors pointing in a first vector direction are successively scanned, before at least one scan vector pointing in a second vector direction which differs from the first vector direction is scanned.

25. The method of claim 18,
wherein a first section of the raw material powder layer is selectively irradiated with linearly polarized laser radiation and a second section of the raw material powder layer is selectively irradiated with randomized laser radiation, radially polarized laser radiation and/or azimuthally polarized laser radiation.

26. The method of claim 25,
wherein the first section of the raw material powder layer is a hatch section of a work piece layer generated by selectively irradiating the raw material powder layer and/or wherein the second section of the raw material powder layer is a contour section of a work piece layer generated by selectively irradiating the raw material powder layer.

27. The method of claim 18,
wherein a plurality of beams of linearly polarized laser radiation are scanned across an overlap section of the raw material powder layer according to a scan strategy, wherein all scan vectors are scanned according to the same scan mode.

28. Irradiation system for irradiating layers of a raw material powder with laser radiation in order to produce a three-dimensional work piece, wherein the irradiation system is configured to selectively irradiate at least a section of a raw material powder layer applied onto a carrier with linearly polarized laser radiation, and wherein the irradiation system comprises a control device which is configured to control an orientation of a plane of polarization of the linearly polarized laser radiation in dependence on an orientation of a plane of incidence of the linearly polarized laser radiation on the raw material.

29. The irradiation system according to claim 28,
wherein the control device is configured:
to control the orientation of the plane of polarization of the linearly polarized laser radiation in dependence on the orientation of the plane of incidence of the linearly polarized laser radiation on the raw material such that the plane of polarization is oriented substantially parallel to the plane of incidence; and/or
to control the orientation of the plane of polarization of the linearly polarized laser radiation in dependence on the orientation of the plane of incidence of the linearly polarized laser radiation on an inner wall surface of a capillary extending from a surface of the raw material powder layer into a volume of the raw material powder layer and being formed due to an interaction of the linearly polarized laser radiation with the raw material.

30. The irradiation system according to claim 28,
wherein the control device, upon controlling the orientation of the plane of polarization of the linearly polarized laser radiation in dependence on the orientation of the plane of incidence of the linearly polarized laser radiation on the raw material, is configured to update the orientation of the plane of polarization of the linearly polarized laser radiation in dependence on a scan direction of the linearly polarized laser radiation across the raw material powder layer.

31. The irradiation system according to claim 30,
wherein the control device is configured to update the orientation of the plane of polarization of the linearly polarized laser radiation based on an analysis of a scan pattern according to which the beam of linearly polarized laser radiation is directed across the raw material powder layer, wherein the analysis of the scan pattern is performed prior to starting the production of the three-dimensional work piece and/or in situ during the production of the three-dimensional work piece.

32. The irradiation system according to claim 28,
wherein the control device is configured:
to control at least one of a power, a focus diameter and a focus shape of a beam (of linearly polarized laser radiation and/or at least one of a scan speed, a scan direction, a scan mode and a scan pattern according to which the beam of linearly polarized laser radiation is directed across the raw material powder layer and/or at least one parameter of a gas flow directed across the raw material powder layer in dependence on an angle of incidence of the beam of linearly polarized laser radiation on the raw material; and/or
to control a scanner unit such that a beam of linearly polarized laser radiation is scanned across the raw material powder layer according to a scan strategy, wherein a plurality of scan vectors pointing in a first vector direction are successively scanned, before at least one scan vector pointing in a second vector direction which differs from the first vector direction is scanned; and/or
to control the irradiation system such that a first section of the raw material powder layer is selectively irradiated with linearly polarized laser radiation and a second section of the raw material powder layer is selectively irradiated with randomized laser radiation, radially polarized laser radiation and/or azimuthally polarized laser radiation, the first section of the raw material powder layer in particular being a hatch section of a work piece layer generated by selectively irradiating the raw material powder layer and/or the second section of the raw material powder layer in particular being a contour section of a work piece layer generated by selectively irradiating the raw material powder layer.

33. The irradiation system according to claim 28,
wherein the control device is configured to control a scanner unit such that a plurality of beams of linearly polarized laser radiation are scanned across an overlap section of the raw material powder layer according to a scan strategy, wherein all scan vectors are scanned according to the same scan mode.

34. Apparatus for producing a three-dimensional work piece which is equipped with an irradiation system of claim 28.
